(19) United States
(12) Patent Application Publication
(10) Pub. No.: US 2007/0092799 A1
(43) Pub. Date: Apr. 26, 2007

(54) Heat resistant separators and electrical and electronic parts using the same

(76) Inventor: Shinji Naruse, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/582,086

(22) PCT Filed: Oct. 26, 2004
(86) PCT No.: PCT/JP04/16197

§ 371 Date: Jun. 8, 2006

(30) Foreign Application Priority Data
Dec. 11, 2003 (JP) 2003-413658

(51) Int. Cl. H01M 2/14

(52) U.S. Cl. 429/247; 429/253; 429/252; 429/254; 429/251

(57) ABSTRACT

This invention provides a separator for electrical or electronic parts which is characterized in that the increase ratio in internal resistance of the separator before and after its heat treatment at 300° C. for 45 minutes is within 25%, where the internal resistance is calculated according to the following equation (1):
(internal resistance)={(electrical conductivity of electrolytic solution/(electrical conductivity of electrolytic solution-injected separator)}×(thickness of separator) equation (1) wherein (electrical conductivity when the electrolytic solution is injected into separator) is the electrical conductivity calculated from the AC impedance measured by sandwiching the electrolytic solution-injected separator between two electrodes.

### TECHNICAL FIELD

This invention relates to separators which separate conductive members in electrical and electronic parts such as condensers, capacitors, batteries and the like, to allow passage of ionic species such as electrolyte or ion; and also to electrical and electronic parts using the separators. In particular, the invention relates to separators which are useful as separator panels between electrodes in electrical and electronic parts using lithium ion, sodium ion, ammonium ion, hydrogen ion or the like as a carrier of electric current.

### BACKGROUND ART

As symbolized by the recent progress in portable communication devices or high-speed information processors, reduction in size and weight and advance in technical performance of electronic instruments are splendid. Above all, more expectation is placed on small size, light weight, and higher capacity and performance electric batteries and capacitors which can withstand storage over prolonged period. Their application range is being broadened and developments of parts utilizing them are under rapid progress. Correspondingly, there are growing needs for developing improved technology and quality for such members as separators which serve as partition plates between electrodes.

Among various properties required for separators, the following three are recognized to be particularly important:

1) that they exhibit good electrical conductivity in the state of holding an electrolyte;

2) that they have high inter-electrodes shielding performance; and

3) that they excel in mechanical strength.

Conventionally, as separators in electrical and electronic parts, porous sheeting of polyolefin polymer film such as of polyethylene or polypropylene (cf. JP Sho63(1988)-273651A); non-woven fabric in which polyolefin polymer fibers such as of polyethylene or polypropylene are made into sheet (cf. JP2001-11761A); non-woven fabric in which nylon fibers are made into sheet (cf. JP Sho58(1983)-147956A) have been widely used. Such separators are used in batteries in the form of mono-layer, multiple layers or wound-up roll.

On the other hand, members used for electrodes are given increased surface areas to impart high capacity. For example, for aluminum electrolytic condenser aluminum foil electrode is etched, and in electric double layer capacitor, activated carbon is used as the electrode, providing fine pores in their surfaces.

### DISCLOSURE OF THE INVENTION

Such micro-porous membranes and non-woven fabric as above possess favorable physical properties for the separator, but do not necessarily fully meet recent demands for condensers, capacitors or batteries for electric cars, for still higher capacity and power output.

A separator for use in electrical and electronic parts for condensers, capacitors, batteries and the like which are required to have high capacity and large power output must simultaneously satisfy the following five property requirements:

1) good electrical conductivity in the state of holding an electrolyte,

2) high inter-electrodes shielding ability,

3) excellent mechanical strength,

4) chemical and electrochemical stability, and

5) capability to withstand high temperature drying (heat resistance).

In particular, heat resistance is considered to be extremely important, for

1) preventing short-circuit between conductive members in electrical and electronic parts using high-intensity electric current, such as batteries as drive power source of electric cars, and

2) thoroughly drying moisture in micropores in electrodes such as of aluminum foil or activated carbon, during manufacturing steps of electrical and electronic parts.

Under the circumstances, the present inventors have engaged in concentrative studies with the view to develop a material for highly heat resistant separators which withstand high-intensity electric current necessitated by higher capacity and large power output and also are durable under high-temperature drying during their manufacturing steps, and now come to complete the present invention.

Thus, the present invention provides a separator for electrical or electronic parts, which is characterized in that the increase ratio in internal resistance of the separator before and after its heat treatment at 300° C. for 45 minutes is within 25%, where the internal resistance is calculated according to the following equation (1):
(internal resistance)={(electrical conductivity of electrolytic solution/(electrical conductivity of electrolytic solution-injected separator)}×(thickness of separator) equation (1)
wherein (electrical conductivity when the electrolytic solution is injected into separator) is the electrical conductivity calculated from the AC impedance measured by sandwiching the electrolytic solution-injected separator between two electrodes.

This invention also provides electrical or electronic parts such as condensers, capacitors, batteries and the like, which are characterized in that the above-described separators are used therein as partition plates between electrically conductive members.

The invention furthermore provides electrical or electronic parts such as condensers, capacitors, batteries and the like, which are characterized in that the above-described separators which have been given a heat treatment at a temperature not lower than 200° C. during their manufacturing steps are used as partition plates between electrically conductive members therein.

Hereinafter the present invention is explained in further details.

<Internal Resistance>

According to the invention, internal resistance of a separator is calculated based on the following equation (1):
(Internal resistance)={(electrical conductivity of electrolytic solution)/(electrical conductivity of electrolytic solution-injected separator)}×(thickness of separator) equation (1)
wherein “electrolytic solution” signifies a liquid formed by dissolving an electrolyte in a solvent.

Kinds of solvent and electrolyte useful for the electrolytic solution and concentration of the electrolyte are subject to no particular limitation. As examples of the solvent, ethylene carbonate, propylene carbonate, dimethyl carbonate, diethyl carbonate, ethylmethyl carbonate, butylene carbonate, glutaronitrile, adiponitrile, acetonitrile, methoxyacetonitrile, 3-methoxypropionitrile, γ-butyrolactone, γ-valerolactone, sulfolane, 3-methylsulfolane, nitroethane, nitromethane, trimethyl phosphate, N-methyloxazolidinone, N,N-dimethylformamide, N-methylpyrrolidone, dimethylsulfoxide, N,N′-dimethylimidazolidinone, amidine, water, and mixtures of two or more of the foregoing can be named.

As examples of electrolyte, ionic substances such as following combinations of cations with anions can be named:

1) cation; e.g., quaternary ammonium ion, quaternary phosphonium ion, lithium ion, sodium ion, ammonium ion, hydrogen ion and mixtures of the foregoing

2) anion; e.g., perchlorate ion, borofluoride ion, hexafluorophosphate ion, sulfate ion, hydroxide ion and mixtures of the foregoing.

(Electrical conductivity of electrolytic solution-injected separator) in the equation (1) is the electrical conductivity calculated from AC impedance as measured by sandwiching the electrolytic solution-injected separator between two electrodes. Measuring frequency for the AC impedance is not critical, but the normally preferred range is 1 kHz-100 kHz.

Separators according to the present invention have the increase rate in internal resistance as expressed by above equation (1) of not more than 25%, in particular, not more than 15%.

<Form of the Separator>

Form or embodiment of the separator according to the invention is subject to no particular limitation so long as it satisfies all of the aforesaid five property requirements simultaneously, i.e.,

1) good electrical conductivity in the state of holding an electrolyte,

2) high inter-electrodes shielding ability,

3) excellent mechanical strength,

4) chemical and electrochemical stability, and

5) capability to withstand high temperature drying (heat resistance).

Whereas, generally suitable form is a sheet. In particular, porous structures such as woven fabrics, non-woven fabrics, paper, microporus film and the like are preferred.

<Separator-constituting Materials>

As the materials for constituting the separators, those having high heat resistance which show little dimensional change when subjected to a heat treatment at temperatures not lower than 250° C., e.g., those whose chief component is at least one of the following are preferred: aramid, wholly aromatic polyester, wholly aromatic polyazo compound, wholly aromatic polyesteramide, wholly aromatic polyether, polyether ether ketone, polyphenylene sulfide, poly-p-phenylenebenzobisthiazole, polybenzoimidazole, poly-p-phenylenebenzobisoxazole, polyamidimide, polyimide, bis-maleimide, triazine, polyaminobismaleimide, polytetrafluoroethylene, ceramic, alumina, silica, alumina-silica, glass, rock wool, silicon nitride, silicon carbide, carbon, zirconia, potassium titanate, magnesium hydroxysulfate and synthetic calcium silicate. Of these, aramid is particularly preferred.

<Preparation of Separators>

Separators of the present invention can be prepared, for example, by processing above separator-constituting materials by an ordinary method, for example, by processing them into staple fiber form of 0.05-25 denier in fineness and around 1-50 mm in length, shaping them into sheet form with a suitable paper machine and heat-pressing the resulting sheet with metallic calendar rolls or the like, e.g., at 100-400° C. under linear pressure of 50-400 kgf/cm.

<Heat Treatment>

Electric and electronic parts in which separators of the present invention are used can be given a heat treatment during their manufacturing steps, for example, after being wound up with electrodes such as of microporous aluminum foil, activated carbon or the like. By such a heat treatment, residual moisture in the micropores can be eliminated. The heat treatment of the separators can be conducted at temperatures not lower than 200° C., for example, by maintaining the separators in a surrounding atmosphere at a temperature range of 300° C.±10° C., for about 45 minutes. The surrounding atmosphere in the occasion is preferably one of a gas not inducing a chemical reaction with the separator, for example, nitrogen or argon, or vacuum.

### EXAMPLES

Hereinafter the invention is explained more specifically, referring to Examples which are given simply for illustrative purpose and never for limiting the scope of the present invention.

<Measuring methods>

(1) BW (Basis Weight) and thickness measurement of sheet

Those methods as prescribed by JIS C2111 were followed.
(2) Measurement of electrical conductivity

A disc of 20 mm in diameter was cut out from a separator, which was sandwiched between two sheets of SUS electrodes and AC impedance at 60 kHz was measured as the basis for the conductivity calculation. The measuring temperature was 25° C. For the measurement, 1M lithium borofluoride solution in ethylene carbonate/propylene carbonate (1:1 by weight) was used as the electrolytic solution.

<Preparation of Starting Materials>

By the method using a wet precipitation machine composed of stator-roter combination as described in JP Sho52(1977)-151624B, fibrid of polymetaphenylene isophthalamide was prepared, which was processed with macerator and refiner to adjust its weight-average fiber length to 1.2 mm.

Separately, metaramid fibers (NOMEX®, DuPont, staple fineness=2.0 denier) were cut into 40 mm and 6 mm in length. Also polyester staple fibers (Tetoron®, Teijin Ltd., stable fineness=0.1 denier) were cut into 5 mm in length, to be used as starting materials for separators.

### Example 1

(Preparation of a Separator)

The metaramid staple fibers (40 mm in length) as prepared in the above were dispersed in water to form a slurry. The slurry was used to form a sheet-formed product with TAPPI sheet machine (cross-sectional area=325 cm²), which was then given a heat-press processing with metallic calendar rolls at a temperature of 295° C. and linear pressure of 300 kgf/cm to provide a separator.

(Heat Treatment)

The separator was then heat-processed in the open air at 300° C. for 45 minutes, with a hot air dryer, during which the separator was maintained perpendicularly with a weight to render its widthwise tension at 0.5 g/mm, for the form retention.

Main property values of so obtained separator were as shown in Table 1.

TABLE 1

| | | | After 45 minutes’ |
|---|---|---|---|
| | | | heat treatment at |
| Property | Unit | Unprocessed | 300° C. |
| BW | g/m² | 40 | 40 |
| Thickness | μm | 80 | 84 |
| Density | g/cm³ | 0.5 | 0.49 |
| Electrical | mS/cm | 2.4 | 2.5 |
| conductivity | | | |
| Internal | μm | 153 | 153 |
| resistance | | | |
| Increase ratio | % | — | 0 |
| in internal | | | |
| resistance | | | |

Electrical conductivity of the electrolytic solution was 4.6 (mS/cm).

### Example 2

(Preparation of a Separator)

The aramid fibrid and aramid staple fibers (6 mm in length) as prepared in the above were separately dispersed in water to form slurries, which were mixed at the fibrid/aramid stable fiber blend ratio (by weight) of 5/95. The blend was formed into a sheet form with TAPPI sheet machine (cross-sectional area=325 cm²). The sheet was given a heat-press processing with metallic calendar rolls at a temperature of 350° C. and linear pressure of 100 kgf/cm to provide a separator.

(Heat Treatment)

The separator was then heat-processed in the open air at 300° C. for 45 minutes, with a hot air dryer, during which the separator was maintained perpendicularly with a weight to render its widthwise tension at 0.5 g/mm, for the form retention.

Main property values of so obtained separator were as shown in Table 2.

TABLE 2

| | | | After 45 minutes’ |
|---|---|---|---|
| | | | heat treatment at |
| Property | Unit | Unprocessed | 300 ° C. |
| BW | g/m² | 40 | 40 |
| Thickness | μm | 133 | 134 |
| Density | g/cm³ | 0.3 | 0.3 |
| Electrical | mS/cm | 1.7 | 1.8 |
| conductivity | | | |
| Internal | μm | 360 | 342 |
| resistance | | | |
| Increase ratio | % | — | −5 |
| in internal | | | |
| resistance | | | |

Electrical conductivity of the electrolytic solution was 4.6 (mS/cm).

As shown in Tables 1 and 2, those separators of Examples 1 and 2 did not show any increase in internal resistance after the heat treatment at 300° C. for 45 minutes, and were considered to have sufficient ion species permeability. They are therefore useful as partition plates between electrically conductive members in electric and electronic parts such as condensers, capacitors, batteries and the like.

### Comparative Example 1

(Preparation of a Separator)

Those aramid fibrid, metaramid staple fibers (6 mm in length) and Tetoron short fibers as prepared in the above were separately dispersed in water to form slurries. The slurries were mixed at the blend ratios of the fibrid/aramid staple fibers/Tetoron® staple fibers as indicated in Table 2, and formed into a sheet-formed product with TAPPI sheet machine (cross-sectional area=325 cm²). The product was then given a heat-press processing with metallic calendar rolls at a temperature of 230° C. and linear pressure of 300 kgf/cm to provide a separator.

Main properties of so obtained separator were as shown in Table 3.

TABLE 3

| | | | After 45 minutes’ |
|---|---|---|---|
| | Unit | | heat treatment at |
| Property | wt % | Unprocessed | 300° C. |
| Composition of | | | |
| starting material | | | |
| Aramid fibrid | | 7 | [symbol] |
| Aramid staple fibers | | 46.5 | [symbol] |
| Polyester staple fibers | | 46.5 | [symbol] |
| BW | g/m² | 20 | 25 |
| Thickness | μm | 33 | 28 |
| Density | g/cm³ | 0.6 | 0.9 |
| Electrical conductivity | mS/cm | 0.56 | 0.05 |
| Internal resistance | μm | 271 | 2576 |
| Increase ratio in | % | — | 851 |
| internal resistance | | | |

Electrical conductivity of the electrolytic solution was 4.6 (mS/cm).

As shown in Table 3, the separator of above Comparative Example showed a notable increase in its internal resistance after the heat treatment at 300° C. for 45 minutes, and its ion species permeability is considered insufficient.

### INDUSTRIAL APPLICABILITY

Because the separators of the present invention show no increase in internal resistance after a heat treatment at 300° C. for 45 minutes and are considered to have sufficient ion species permeability, they are useful as partition plates between electrically conductive members in electric and electronic parts such as condensers, capacitors, batteries and the like. Those electrical and electronic parts such as condensers, capacitors, batteries and the like, in which separators of the present invention are used, can be dried at high temperatures during their manufacturing steps, concurrently with electrodes therein of microporous aluminum foil, activated carbon and the like, achieving the effect that no adverse effect on electrical characteristics of the electrical and electronic parts such as condensers, capacitors, batteries and the like is incurred by residual moisture.

1. A separator for electrical or electronic parts wherein the increase ratio in internal resistance of the separator before and after its heat treatment at 300° C. for 45 minutes is within 25%, where the internal resistance is calculated according to the following equation (1):
(internal resistance)={(electrical conductivity of electrolytic solution/(electrical conductivity of electrolytic solution-injected separator)}×(thickness of separator) equation (1)
and wherein (electrical conductivity when the electrolytic solution is injected into separator) is the electrical conductivity calculated from the AC Impedance measured by sandwiching the electrolytic solution-injected separator between two electrodes.

2. A separator as set forth in claim 1, in the form of woven fabric, non-woven fabric, paper or micro-porous film.

3. A separator as set forth in claim 1 or 2, composed of a constituent material whose chief component is at least one substance selected from the group consisting of aramid, wholly aromatic polyester, wholly aromatic polyazo compound, wholly aromatic polyesteramide, wholly aromatic polyether, polyether ether ketone, polyphenylene sulfide, poly-p-phenylenebenzobisthiazole, polybenzoimidazole, poly-p-phenylenebenzobisoxazole, polyamidimide, polyimide, bis-maleimide, triazine, polyaminobismaleimide, polytetrafluoroethylene, ceramic, alumina, silica, alumina-silica, glass, rock wool, silicon nitride, silicon carbide, carbon, zirconia, potassium titanate, magnesium hydroxysulfate and synthetic calcium silicate.

4. Electrical and electronic parts wherein the separators as set forth in claim 1 or 2 are used as partition plates between electrically conductive members therein.

5. Electrical and electronic parts wherein the separators as set forth in claim 1 or 2 which have been heat treated during their manufacturing steps at temperatures not lower than 200° C. are used as partition plates between electrically conductive members therein.

6. Electrical and electronic parts wherein the separators as set forth in claim 3 are used as partition plates between electrically conductive members therein.

7. Electrical and electronic parts wherein the separators as set forth in claim 3 which have been heat treated during their manufacturing steps at temperatures not lower than 200° C. are used as partition plates between electrically conductive members therein.
